(19) United States
(12) Patent Application Publication
(10) Pub. No.: US 2013/0214759 A1
(43) Pub. Date: Aug. 22, 2013

(54) LONG-DISTANCE CONSTANT-VOLTAGE ELECTRICITY-FEEDING METHOD WITH WAKE-UP FUNCTION AND SYSTEM

(71) Applicants: Xiangning Chen, Nanjing (CN); Lifang Hao, Nanjing (CN); Jie Zhang, Nanjing (CN)

(72) Inventors: Xiangning Chen, Nanjing (CN); Lifang Hao, Nanjing (CN); Jie Zhang, Nanjing (CN)

(21) Appl. No.: 13/882,137

(22) PCT Filed: Sep. 8, 2011
(86) PCT No.: PCT/CN2011/079458

§ 371 Date: Apr. 26, 2013

(30) Foreign Application Priority Data
Oct. 28, 2010 (CN) 201010522791.6

(51) Int. Cl. H02J 4/00

(52) U.S. Cl. CPC H02J 4/00
USPC 323/318

(57) ABSTRACT

Disclosed are a wired long-distance constant-voltage electricity-feeding method with a wake-up function and a system. A smart electricity supply module of a central electricity supply device generates a feed voltage from a central electricity source, and feeds the voltage to a terminal electricity source module through a feed line. Said smart electricity supply module can continuously provide electricity at a constant voltage to the terminal electricity source module and can change feed voltage polarity according to set rules when the terminal electricity module in sleep-mode must be remotely waken up. A voltage polarity monitoring module of said terminal electricity source module can determine, by monitoring the polarity of the voltage of the centrally fed electricity, whether to wake up the terminal electricity source module from sleep-mode to enter a normal electricity-supplying mode. The electrical feed circuit and the wake-up function are easy to implement, and provide a versatile power feed and high energy efficiency while reducing withstand-voltage process requirements.

### FIELD OF THE INVENTION

The present invention pertains to intelligent long-distance constant-voltage feeding method and system, and in particular relates to long-distance constant-voltage feeding method and system with wake-up function.

### BACKGROUND OF THE INVENTION

An ordinary line telephone system feeds power to terminal devices remotely through twisted pair lines. Actually, most telecommunication terminal devices obtain power supply required for normal operation from the local side at a telecom agency through twisted pair lines. The device that feeds power from the local side is referred to as power supply device, while the device that receive long-distance feeding at the terminal side is referred to as a powered device. Feeding from the local side can improve the availability of the telecommunication system, and is a design objective for remote telecommunication devices.

The implementation block diagram of long-distance power supply in an ordinary telephone system is shown in FIG. 1. The feeding system that feeds power from the local side to a remote device comprises an local side battery, a power supply and monitoring module (12), transformers (14 and 15), a twisted pair lines (3), a switch hook (K), a rectifier bridge and voltage regulator module (22), and necessary interconnecting circuits between the modules. The power supply and monitoring module (12) in the power supply device (1) at the local side generates feeding voltage from input DC voltage (V_{A}), and the feeding voltage is applied to local side ports (T-R) of the twisted pair telephone lines via the transformers (14 and 15). Here, the transformers (14 and 15) are equivalent to low-pass filter inductors for DC power feeding, and have no influence on the power of the feeding power source. According to GB-T15279 standard, in on-hook state, the switch hook (K) of telephone (2) is in OFF state, the leak current of the telephone shall be lower than 25 μA, and the feeding voltage of the power supply device (1) at the local side shall be 48 VDC; in off-hook state, the switch hook (K) is in closed state, and the DC resistance of the telephone must be lower than 350Ω; when the power supply and monitoring module (12) determines that the telephone is in off-hook state by detecting the feeding current, on one hand, it will send the off-hook state via a port (W) to other modules at the local side for further treatment, on the other hand, it will adjust the feeding output voltage to about 10V. When a power supply and monitoring module (12) at the local side that supports long-distance billing indication function has information to transmit, according to the indication of the feeding control port (J) it will initiate billing function by swapping the polarity of feeding voltage, i.e., exchanging the positive/negative polarity of the feeding voltage outputted via the ports (T-R).

To inform a called subscriber of an incoming call, a ringing current generator module (13) is arranged in the device (1) at the local side, and a prompting module (23) is arranged in the telephone (2). When the switch hook is in OFF state, the equivalent impedance of the prompting module (23) of telephone (2) shall be greater than 3KΩ. In prompt state, the ringing current generator module (13) at the local side generates alternating voltage of about 90V, 25 Hz, which is outputted via the transformers (14 and 15) to the ports (T-R) at the local side. The ringing current generator module (13) generates ringing current voltage in an intermittent manner, i.e., working for 1 second, and pausing for 4 seconds. In the 1 second period when the ringing current generator module (13) outputs ringing current voltage, the feeding voltage output and the feeding current detection function of the power supply and monitoring module (12) are paused; in the 4 seconds period when the ringing current generator module (13) stops ringing current voltage output, the feeding voltage output and the feeding current detection function of the power supply and monitoring module (12) are enabled.

After the Caller Identification (CID) technique is launched, the telephone shall display the incoming call number to the subscriber, before the subscriber lifts off the hook. To meet that demand, the feeding system at the local side can tolerate higher drain current of the terminal device instead of concluding a judgment that the subscriber has lifted off the hook.

The new xDSL technique is the developing trend of telecommunication systems in the future. Most xDSL remote devices have high power consumption, and usually the power of a complete device exceeds 2 W. However, conventional telephone feeding systems can only provide feeding power not higher than 0.8 W, which can not meet the demand of xDSL remote devices for normal operation.

In addition, the old-fashioned ringing current approach will not survive, because it results in high power consumption and high cost, and the music rings provided by most telephones are more favorable. The ringing current function at local side should be canceled to optimize the design of feeding system at local side.

It is known to all that the convenience and reliability of remote telecommunication devices largely depends on the feeding technique at the telecommunication local side. Remote telecommunication devices (e.g., telephone) can operate normally without local power supply, and therefore are not affected by power outage or power supply failure of the local electric network. If local power supply must be used because the power fed from the telecommunication local side is too low, the improvement of convenience and reliability of remote telecommunication devices will be limited. Therefore, various long-distance power supply specifications and techniques have been developed, such as IEEE 802.3af PoE (Power over Ethernet) standard and many patents related with long-distance power supply.

Wherein, the IEEE 802.3af PoE standard provides a method for transmitting power source from the power supply equipment (PSE) to powered devices (PDs) through Ethernet cables. Electric power is supplied over Ethernet through three steps: (1) first, the PSE transmits 2.8V to 10V testing voltage, to detect whether the corresponding port of cable has valid common mode resistance and characteristic capacitance. If 19KΩ to 26.5KΩ common mode resistance exists and the capacitance of the port is lower than 150 pF, it indicates there is a PD that supports PoE; if the common mode resistance is smaller than 15KΩ or greater than 33KΩ or the capacitance of the port is greater than 100, it indicates there is no PD that supports PoE; (2) next, the PSE applies 15 to 20V testing voltage to the PD through an Ethernet cable, and the power level of the PD is determined by measuring the current. In that standard, according to required power PDs are classified into five levels, and are deemed as requiring Class 0 power level by default; (3) finally, the PSE applies 48V DC voltage with specified polarity to the PD through the Ethernet cable, and provides power not higher than 15.4 W.

According to IEEE standard, the Ethernet PSE can multiplex two twisted pair lines (3, 4) that are used for transceiving data (10S, 10R, 20R, 20S) to provide long-distance feeding FIG. 2(a), or use two twisted pair lines that are usually spare to provide long-distance feeding FIG. 2(b).

In the case that the power is fed over Ethernet by multiplexing the twisted pair lines that are used for transceiving data (FIG. 2(a)), the positive terminal of DC power output from the PSE at the local side (1A) is connected to the center tap at cable side of Ethernet transmitting isolation transformers (16, 17), and the negative terminal of DC power output is connected to the center tap at cable side of Ethernet receiving isolation transformers (26, 27). Therefore, when electric power is supplied, the output at the center tap at cable side of the Ethernet transmitting isolation transformer of the PD at terminal (2A) is supplied by the negative feeding terminal, while the output at the center tap at cable side of the Ethernet receiving isolation transformer is supplied by the positive feeding terminal.

In the case that the power is fed over Ethernet by using two spare twisted pair lines FIG. 2(b), the positive terminal of DC power output from the PSE at the local side (1B) is connected to the pin 4 and 5 of the RJ45, and the negative terminal of DC power output is connected to the pin 7 and 8 of the RJ145 at the same time. Therefore, when electric power is supplied, the output at the pin 4 and 5 of Ethernet RJ45 interface of the PD at terminal (2B) is supplied by the positive feeding terminal, while the output at the pin 7 and 8 of Ethernet R345 interface is supplied by the negative feeding terminal.

PoE is not suitable for long-range telecommunication applications, because the coverage radius of Ethernet is less than 100 meters.

The issued patent 200510068309.5 puts forward a scheme that utilizes signal twisted pair lines and supervisory signal twisted pair lines to supply power to the terminal power supply modules. Wherein, a control module is arranged at the local side, a monitoring module is arranged at the remote side, and two supervisory signal twisted pair lines are arranged specially to transmit supervisory and interactive control signals provided by the PD, so as to attain the purpose of improving the maintainability of the terminal power supply module by monitoring the terminal power supply module.

It is seen that there is no wake-up mechanism that can wake up the power supply module of a terminal which requires long-distance power supplying and is in sleep mode in a simple and clear way with the various existing long-distance constant-voltage power supply techniques; whereas, in future constant-voltage feeding systems, it is expected to achieve a more flexible wake-up mechanism on the basis of implementation of long-distance power supplying, so as to conveniently wake up a terminal power supply module that requires long-distance power supplying and is in sleep mode and drive the power supply module to enter into normal power supply state at any time as required, so as to provide required operating voltage to household electric appliances or other public electric devices.

### DISCLOSURE OF THE INVENTION

### Technical Problem

To explain the object of the present invention in summary, herein some aspects, advantages, and novel characteristics of the present invention are described. It should be understood that not all these aspects, advantages, and characteristics have to be included in any specific embodiment.

The object of the present invention is to provide long-distance constant-voltage feeding method and system, in particular to a long-distance constant-voltage feeding method and system with wake-up function.

### Technical Solution

The long-distance constant-voltage feeding method with wake-up function provided in the present invention comprises an intelligent power supply module, a terminal power supply module, and a feeding line that connects the intelligent power supply module and terminal power supply module, wherein:

the intelligent power supply module can provide constant-voltage feeding to the terminal power supply module continuously, and can change the polarity of feeding voltage in accordance with predefined rules when the terminal power supply module is to be waken up remotely from sleep mode;

the intelligent power supply module monitors the active state of the terminal power supply module constantly, and outputs the monitored active state of the terminal power supply module to other modules at the local side;

the terminal power supply module is in sleep mode initially and consumes lower feeding current, and will consume higher feeding current and begin to provide normal operating voltage to the locally connected electric device after it is waken up and enters into normal power supply state.

Preferably, the terminal power supply module comprises a voltage polarity monitoring module.

Preferably, the voltage polarity monitoring module decides whether to wake up the remote terminal power supply module from sleep mode into normal power supply state according to the polarity of feeding voltage from the local side.

Preferably, the voltage polarity monitoring module can further decide whether to wake up the terminal power supply module from sleep mode into normal power supply state according to the parameter of polarity change of feeding voltage from the local side.

A long-distance constant-voltage feeding system with wake-up function, comprising an intelligent power supply module, a terminal power supply module, and a feeder line that connects the intelligent power supply module and the terminal power supply module, wherein:

the intelligent power supply module comprises a power supply module that can provide constant-voltage feeding to the terminal power supply module constantly, a voltage polarity control module that will change the polarity of outputted feeding voltage in accordance with predefined rules when the terminal power supply module is to be waken up remotely from sleep mode, and a current detection module that monitors the active state of the terminal power supply module constantly and outputs the monitored active state of the terminal power supply module to other modules at the local side;

the terminal power supply module is in sleep mode initially and consumes lower feeding current, and will consume higher feeding current and begin to provide normal operating voltage to the locally connected electric device after it is waken up and enters into normal power supply state.

The terminal power supply module comprises a voltage polarity monitoring module and a stabilized voltage supply module.

The voltage polarity monitoring module can decide whether to activate the stabilized voltage supply module into normal operating state according to the parameter of polarity change of feeding voltage from the local side.

The stabilized voltage supply module is in standby state initially, and will enter into normal operating state after it is activated; in addition, the stabilized voltage supply module consumes very low current in standby state, and provides normal operating voltage to the connected electric device and consumes higher current when it is in normal operating state.

### Beneficial Effects

1. Flexible Feeding

With the conventional long-distance feeding scheme for telephones, owing to the limitation of the signal processing module, the feeding at the local side will be lowered by about 10V when the device at the local side detects the remote device is in normal operating state; as a result, the feeding power from the local side to the distal end is severely limited. With the long-distance feeding method disclosed in the present invention, a pair of transformers are added at the local side and the distal end respectively, so that the communication signals and DC feeding arc separated from each other timely and effectively, or the communication signals and DC feeding are fed through different lines; thus, the feeding from the local side is not limited by the signal processing module and the long-distance feeding voltage will not be lowered. In addition, with the feeding method disclosed in the present invention, positive voltage and negative voltage can be fed from the local side as required, and therefore the feeding method is very flexible.

2. High Feeding Power

With the existing feeding method for telephones in the prior art, the maximum power can not be higher than 800 mW. The present invention employs a constant-voltage feeding method, which allows the feeding current to increase when the electric device is in off-hook operating state; therefore, the feeding power is greatly increased and can be higher than 4 W; thus, the present invention can be used to feed power to remote communication devices or other electric devices.

3. Simple and Easy-to-Implement Feeding Circuit

The present invention employs constant-voltage feeding, and does not require voltage adjustment between on-hook state and off-hook state; therefore, the ringing current generator module at the local side can be shielded, and the feeding circuit is simple and easy to implement.

4. Lowered Requirement for Voltage Withstand Process

With the improved solution of the present invention, the ringing current generator module that generates voltage as high as 90V AC in the conventional feeding system for telephones is completely omitted, the maximum operating voltage of the entire system is decreased to 48V DC, and the requirement for safety protection against electric leakage and electric shock and requirement for voltage withstand process of the system are greatly lowered; therefore, the system can be applied more widely and the integration level of the system can be further improved.

### BRIEF DESCRIPTION OF THE DRAWINGS

FIG. 1 is a schematic diagram of implementation of interface device at telecommunication local side and subscriber telephones in the background art of the present invention.

FIG. 2 is a schematic diagram of power supply over Ethernet (PoE) in the background art of the present invention.

FIG. 3 is a schematic diagram of system implementation of a point-to-point embodiment of the present invention.

FIG. 4 is a schematic diagram of feeder line connection in a sample system in which a twisted pair line is used as the feeder line

FIG. 5 is a schematic diagram of feeder line connection in which a twisted pair line and a conductive wire are used as the feeder line.

FIG. 6 is a schematic diagram of feeder line connection in which two twisted pair lines are used as the feeder line.

FIG. 7 is a schematic diagram of three implementation schemes of the power supply module 41 in an embodiment of the present invention.

FIG. 8 is a schematic diagram of three implementation schemes of the current detection module 42 in an embodiment of the present invention.

FIG. 9 is a schematic diagram of two implementation schemes of the output voltage polarity control module 43 in an embodiment of the present invention.

FIG. 10 is a schematic diagram of two implementation schemes of the stabilized voltage supply module in an embodiment of the present invention.

FIG. 11 is a schematic diagram of three implementation schemes of the voltage polarity monitoring module in a point-to-point embodiment of the present invention.

FIG. 12 is a schematic diagram of an implementation scheme of the local control circuit in an embodiment of the present invention.

FIG. 13 is a schematic diagram of an implementation scheme of a first point-to-multipoint embodiment that utilizes a voltage polarity monitoring module and multiple regulated power supply modules in combination.

FIG. 14 is a schematic diagram of system implementation of a second point-to-multipoint embodiment of the present invention.

FIG. 15 is a schematic diagram of an implementation scheme of the terminal power supply module in electric device in the second point-to-multipoint embodiment.

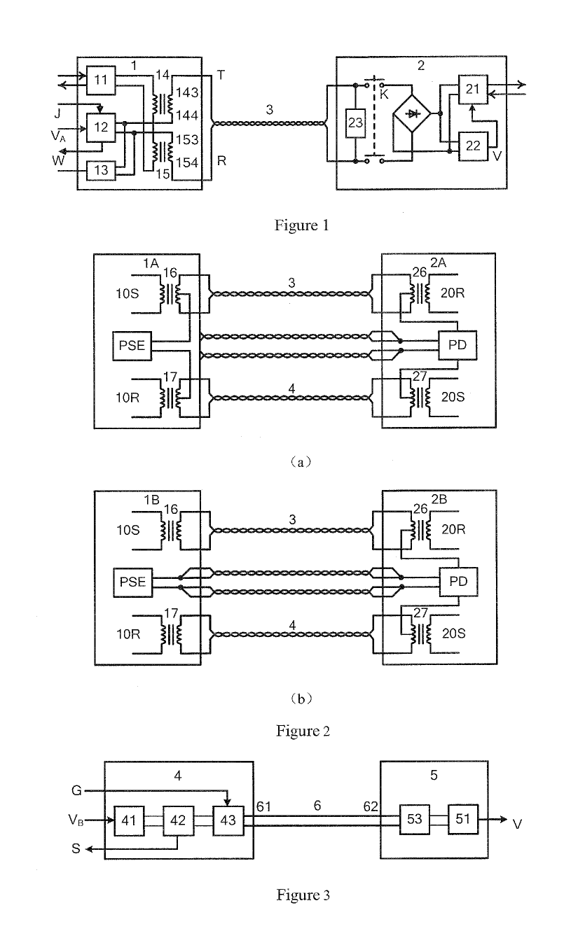

### DETAILED DESCRIPTION OF THE EMBODIMENTS

Hereunder the embodiments of the present invention will be described. To simplify the description of these embodiments, not all characteristics of the actual implementation scheme are described here. It shall be understood that some other specific decisions for a specific application may have to be made in the development process of any actual implementation scheme, so as to meet the constraint conditions related with specific system and service. For those having ordinary skills in the art who can benefit from the content disclosed here, these complex and time-consuming decisions are only common tasks in design, manufacturing, and production.

In the description of specific implementation schemes, to match different actual application scenarios, the implementation schemes will be categorized into two categories. One category covers point-to-point long-distance. constant-voltage feeding method and system with wake-up function, and the other category covers point-to-multipoint long-distance constant-voltage feeding method and system with wake-up function.

First, the specific implementation scheme of point-to-point long-distance constant-voltage feeding method and system with wake-up function will be described hereunder.

The core method of point-to-point long-distance constant-voltage feeding scheme with wake-up function is: arranging an intelligent power supply module at the local side, arranging a terminal power supply module at the terminal, and connecting the intelligent power supply module and terminal power supply module through a feeder line.

The terminal power supply module is in sleep mode initially and consumes very low feeding current; after it is waken up remotely or locally, it will enter into normal power supply state and begin to provide operating voltage required for normal operation to a electric device connected to it or multiple electric devices connected in parallel with it, and will consume higher current fed through the feeder line.

The intelligent power supply module provides constant-voltage feeding with determined polarity to the terminal power supply module in normal state; it will change the polarity of the outputted feeding voltage when the terminal power supply module is to be waken up remotely from sleep mode, and will monitor the magnitude of feeding current in the feeder line constantly; if it finds the feeding current is lower than a specified threshold, it will judge that the terminal power supply module is in sleep mode; if it finds the feeding current is higher than the specified threshold, it will judge that the terminal power supply module is in normal power supply state; in addition, it decides whether to output the monitored sleep mode/normal power supply state of the terminal power supply module to other modules at the local side according to the actual demand.

The implementation method for the intelligent power supply module to wake up the terminal power supply module remotely into normal power supply state in normal state is: arranging a control circuit at the local side in the intelligent power supply module, wherein, the control circuit is designed to invert the polarity of the outputted feeding voltage as a wake-up signal in accordance with predefined rules when the terminal power supply module is to be waken up as instructed by control instructions of other modules at the local side; and arranging a voltage polarity monitoring module in the terminal power supply module to identify the wake-up signal and activate a stabilized voltage supply module belonging to the terminal power supply module into normal operating state and thereby activate the entire terminal power supply module into normal power supply state according to a monitored wake-up signal.

The method for waking up the terminal power supply module into normal power supply state locally can be implemented with a simple local switching circuit or a simple local control circuit.

Hereunder the long-distance constant-voltage feeding method with wake-up function in the present invention will be further described with the specific implementation circuit of a point-to-point long-distance constant-voltage feeding system with wake-up function.

The point-to-point long-distance constant-voltage feeding system with wake-up function comprises an intelligent power supply module 4, a terminal power supply module 5, and a feeder line 6 that connects the intelligent power supply module 4 and terminal power supply module 5, as shown in FIG. 3.

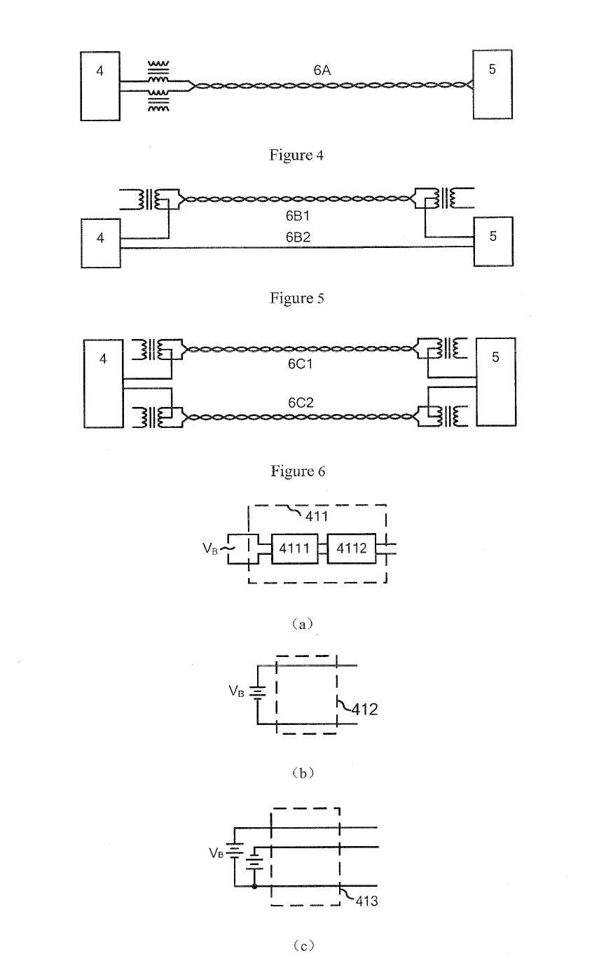

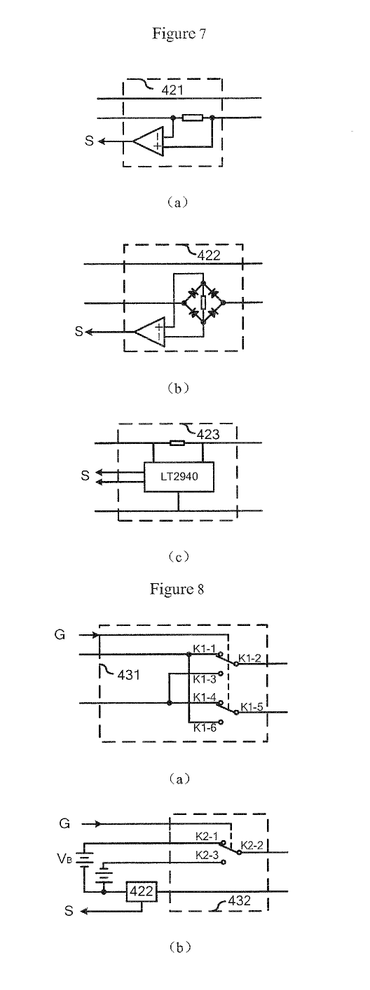

The connection of intelligent power supply module 4 and terminal power supply module 5 to the feeder line 6 can be a direct connection as shown in FIG. 3, or a coupled connection via an intermediate apparatus. As shown in FIGS. 4, 5, and 6, the intelligent power supply module 4 at the local side and the terminal power supply module 5 are couple-connected to the feeder line via transformers in different ways.

The feeder line for connecting the intelligent power supply module 4 and the terminal power supply module 5 can be a conductive cable in a variety of forms.

The simplest implementation of the feeder line 6 is two parallel conductive wires, as shown in FIG. 3. FIGS. 4, 5, and 6 show different implementation methods of the feeder line 6 respectively, i.e., a twisted pair line 6A; a twisted pair line 6B1 and a conductive wire 6B2; and two twisted pair lines 6C1 and 6C2. For low-frequency equivalent circuits, the implementation schemes of the feeder line in the embodiments are equivalent to that shown in FIG. 3 in terms of circuitry, owing to the fact that the coupling transformers in the described connection methods are equivalent to serially connected resistors and the twisted pair line is equivalent to a single straight wire for the transmission of wake-up signal and power supply state signal.

The intelligent power supply module 4 feeds constant-voltage feeding with determined polarity to the terminal power supply module in normal state, and will change the polarity of outputted feeding voltage in accordance with predefined rules and feed the power to the terminal power supply module 5 through the feeder line 6 when the terminal power supply module 5 is to be waken up. In addition, the intelligent power supply module 4 at the local side can detect the current output to the feeder line 6, and will judge that the terminal power supply module 5 has already been waken up and has entered into normal power supply state when the current in the feeder line exceeds the specified threshold.

The intelligent power supply module 4 can be a separate device, or can he a part of other devices, similar to the power supply and monitoring module 12 in the power supply equipment at local side for ordinary analog telephones.

To implement the long-distance constant-voltage feeding method with wake-up function, the intelligent power supply module 4 at the local side in this embodiment comprises: an input power supply port VB, a control port G, a remote state output port S, a feeder line output port 61, a power supply module 41, a current detection module 42, and an output voltage polarity control module 43.

The power supply module 41 obtains electric energy from the input power supply port VB, transforms the voltage, and outputs the power at constant voltage to other modules in the intelligent power supply module 4.

If the power supply port VB supplies AC power, an implementation scheme of the power supply module 41 comprising an AC/DC voltage converter module 4111 and a voltage regulator module 4112, as illustrated by the power supply module 411 shown in FIG. 7(a). Wherein, the AC/DC voltage converter module 4111 can employ a proven chip available in the market according to the actual demand, such as the SA series TYPE models of AC/DC converter chips from Guangzhou Aipu Electron Technology Co., Ltd, which can work at input voltage of 85 VAC to 256 VAC and provide output voltage of 2 VDC to 48 VDC. Likewise, the voltage regulator module (4112) can employ a proven chip available in the market according to the actual demand, such as the SRD_(M)P_{—}3S series from Mornsun Guangzhou Science &Technology Co., Ltd., which can work within input voltage range from 5V to 80V and provide output voltage of 5V to 24V; or, the new high-power voltage regulator module developed by VICOR company (USA) with “zero-current switching” technology, which can work within input voltage range from 10V to 400V and provide output voltage of 2V to 48V and even up to output voltage of 95V.

For a system that is powered steadily with battery, the power supply module can even be the modules 412 and 413 connected through simple straight wires shown in FIGS. 7(b) and 7(c).

The current monitoring module 42 can be an ammeter, or the current detection circuit 421 shown in FIG. 8(a), or the current detection circuit 422 shown in FIG. 8(b), or the current detection module 423 shown in FIG. 8(c), wherein, the proven commercial chip LT2940 in the current detection module 423 can accomplish both current detection and power detection when the input voltage is within a range of 4V to 80V. If the current detection module 42 detects the feeding current is lower than a specified threshold, it will judge that the terminal power supply module 5 at the distal end is in sleep mode; if detects the feeding current is higher than the specified threshold, it will judge that the terminal power supply module 5 is in normal power supply state; in addition, the current detection module 42 outputs the monitored sleep mode/normal power supply state of the terminal power supply module via the long-distance state output port S.

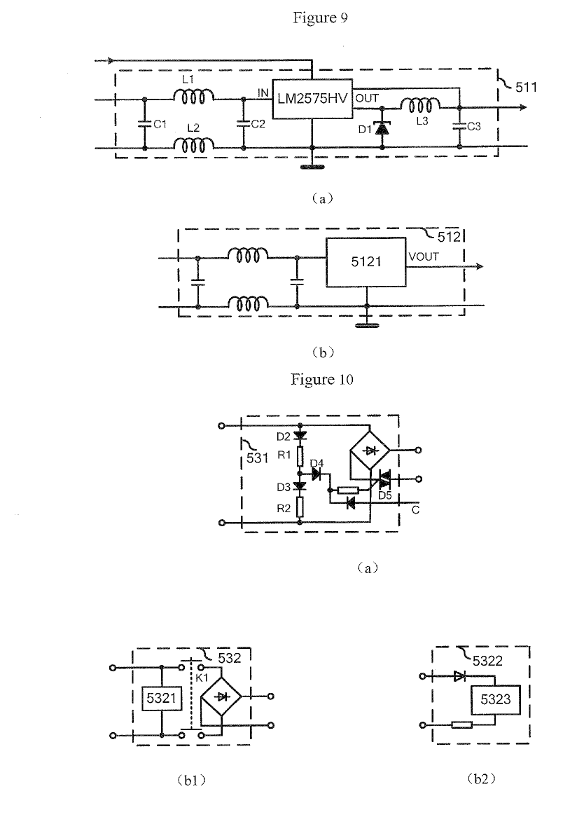

The voltage polarity control module 43 will control the power supply module 41 to output long-distance feeding voltage with specified polarity as a wake-up signal to the feeder line output port 61 in accordance with the instruction of the control port G when the terminal power supply module 5 is to be waken up. The two implementation schemes are shown as K1 in the voltage polarity control module 431 in FIG. 9(a) and K2 in the voltage polarity control module 432 in FIG. 9(b); or feeding voltage output with determined polarity can be implemented with a relay, or feeding voltage output with specific polarity can be implemented with a full-bridge drive circuit with a proven chip available in the market, such as LMD18245 from National Semiconductor Corporation (USA), UBA2036 from NXP Semiconductors (the Netherlands), and A3959 from Allegro Corporation; all of these chips can utilize the control signal inputted via the control port G to control the polarity of outputted feeding voltage conveniently. See the recommended reference designs in the related manuals of the chips for the specific circuits.

The terminal power supply module 5 is in sleep mode initially, and will enter into normal power supply state and begin to provide normal operating voltage to the local electric device, and feed back its power supply state signal to the intelligent power supply module 4 through feeder line 6, after it is waken up.

The terminal power supply module 5 has very low leak current in sleep mode; once it is waken up and enters into normal power supply state, the current flow in the feeder line will increase sharply; therefore, the current in the feeder line can be used as a power supply state signal. When the current in the feeder line is lower than a specific threshold, the terminal power supply module 5 can be deemed as in sleep mode; when the current in the feeder line is higher than the specific threshold, the terminal power supply module 5 can be deemed as already in normal power supply state.

The terminal power supply module 5 provides constant normal operating voltage to the electric device at the terminal when it is in normal power supply state. In this embodiment, the terminal power supply module 5 comprises: a feeder line port 62, a voltage polarity monitoring module 53, a stabilized voltage supply module 51, and a local power output port V.

The stabilized voltage supply module 51 is in standby state initially and consumes very low drain current, and thereby the terminal power supply module is in sleep mode; when the stabilized voltage supply module 51 is activated into normal operating state and begins to provide normal operating voltage to the connected electric device, the consumed feeding current will increase sharply, and thereby the terminal power supply module will enter into normal power supply state.

The stabilized voltage supply module 51 can be in two forms: a voltage-regulating IC chip with an Enabled control terminal, or a stabilized voltage supply without Enabled control terminal.

In the case a voltage-regulating IC chip with an Enabled control terminal is used, the stabilized voltage supply module in a preferred embodiment comprises three branch circuits: a filter circuit (C1, L1, L2, and C2) connected to an input port (IN), an integrated stable voltage circuit (LM2575HV, L3 and D1), and a filter circuit (C3) connected to an output port (OUT), as illustrated by the regulated power supply module 511 in FIG. 10(a). When the stabilized voltage supply module 511 receives an Active Low control signal outputted from the voltage polarity monitoring module 53, it will obtain electric energy from the feeder line, transform the voltage, and output constant voltage, so as to provide constant DC voltage to the local electric device. The stabilized voltage supply module 51 can be implemented with a proven chip available in the market, such as μA78S40 from Motorola, TNY268 from POWER, and NCP3063 from ON Semiconductor, etc., besides LM2575HV from National Semiconductor Corporation (USA). See the description and recommended reference designs in the related manuals of the chips for the specific circuits.

The stabilized voltage supply module 511 in a preferred embodiment employs a voltage-regulating IC chip LM2575HV with an Enabled control terminal. More DC stabilized voltage supplies that are more typical may have no Enabled control terminal. In these cases, the stabilized voltage supply module 512 shown in FIG. 10(b) can be used. When long-distance feeding input exists at the input terminal of the stabilized voltage supply 512, the voltage is regulated and steady DC voltage is outputted from the output port (VOUT) for normal operation of the local electric device. The voltage 5121 can employ any proven commercial stabilized voltage supply module that is suitable for the embodiment.

Since a function of polarity inversion of long-distance feeding voltage is required, the stabilized voltage supply module shall be connected in series with a rectifier module in front of its input terminal, to ensure the input power polarity required for normal operation of the DC regulated power supply module.

The voltage polarity monitoring module 53 can monitor the polarity of feeding voltage at the local side, and can control the stabilized voltage supply module 51 to receive long-distance feeding electric energy and enter into normal operating state and thereby wake up the entire terminal power supply module into normal power supply state to start outputting steady constant-voltage feeding to the local electric device when the monitored feeding voltage polarity is a wake-up signal.

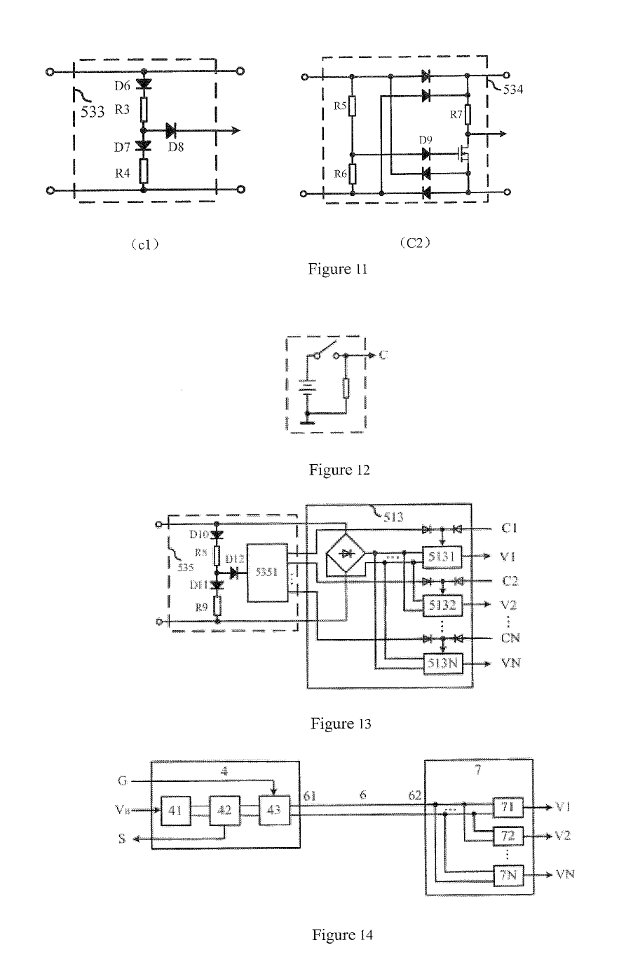

In the case that the stabilized voltage supply module 51 is a stabilized voltage supply module without Enabled control terminal, an implementation scheme of the voltage polarity monitoring module 53 can comprise a unidirectional (or bidirectional) thyristor D5 and a circuit that provides control signals to the thyristor, as shown in FIG. 11(a). Implementation of this wake-up procedures are as follows:

Set the polarity of voltage output of the intelligent power supply module 4 in normal state to polarity that causes cut-off of the diodes D2, D3, and D4; in that state, the thyristor is in cut-off state, and therefore the stabilized voltage supply module has very low drain current input and is in standby state; as a result, the entire terminal power supply module 5 consumes very low feeding current and is in sleep mode;

When the intelligent power supply module 4 is to wake up the terminal power supply module 5 in sleep mode remotely in normal state, the equipment at the local side will control the intelligent power supply module with a control signal inputted via the control port G to output voltage with polarity that will cause the diode D2 to enter into ON state, so as to provide control triggering voltage to the thyristor D5 by means of the divided voltage on R1 and R2; as a result, long-distance feeding voltage will be rectified by the rectifier bridge and fed to the input terminal of the stabilized voltage supply module, and the stabilized voltage supply module 51 will be activated into normal operating state, and thereby the entire terminal power supply module 5 will be waken up into normal power supply state and begin to provide operating voltage to the local electric device. Now, the terminal power supply module consumes higher feeding current. When the feeding current exceeds the specified threshold, the intelligent power supply module will judge that the terminal power supply module has entered into normal power supply state and output the state to other modules at the local side via the remote state output port S;

When the terminal power supply module in sleep mode is to be waken up locally, a control triggering voltage signal can be provided to a bidirectional thyristor through a local control circuit (C), so that the diode D4 gates on and triggers the thyristor D5 into ON state, and thereby the terminal power supply module is waken up locally into normal power supply state; now, the terminal power supply module consumes higher feeding current; when the feeding current exceeds the specified threshold, the intelligent power supply module at the local will judge that the terminal power supply module is in normal power supply state, and output the state to other modules at the local side via the remote state output port S.

The embodiment shown in FIG. 11(a) further comprises a resistor for current limiting protection, which should be considered in the actual application. The actual protection circuit can be more complex. The description here is only illustrative, and does not constitute any limitation to the form of the protection circuit.

An implementation scheme of the local control circuit is shown in FIG. 12. The illustrative scheme employs a battery and a switch, and the control voltage signal for switching on the thyristor can be generated by closing the switch manually.

In the case that the stabilized voltage supply module 51 is a stabilized voltage supply module without Enabled control terminal, another implementation scheme of the voltage polarity monitoring module 53 comprises a voltage polarity monitoring and prompting circuit 5321 and a switch fork K1, as shown in FIG. 11(b1), wherein, an implementation scheme of the voltage polarity monitoring and prompting circuit 5321 comprises a diode, a resistor, and a buzzer 5323 in series, as shown in FIG. 11(b2). Implementation of this wake-up procedures are as follows:

Set the polarity of voltage output of the intelligent power supply module 4 in normal state to polarity that causes cut-off of the diode in the voltage polarity monitoring and prompting circuit 5322; in that state, the switch hook is in OFF state, and therefore the stabilized voltage supply module does not consume current and is in standby state; as a result, the entire terminal power supply module 5 consumes lower feeding current and is in sleep mode;

When the intelligent power supply module is to wake up the terminal power supply module in sleep mode remotely in normal state, the equipment at the local side will control the intelligent power supply module with a control signal inputted via the control port G to output voltage with polarity that will cause the diode in the voltage polarity monitoring and prompting circuit 5322 to enter into ON state, so that feeding voltage will be applied to the buzzer, and the buzzer will give off a singing or music, to prompt the operator to close the switch hook K1, so as to feed the feeding voltage to the input terminal of the rectifier bridge; the feeding voltage will be rectified by the rectifier bridge, and fed with correct polarity to the input terminal of the stabilized voltage supply module to activate the stabilized voltage supply module into normal operating state, and thereby the entire terminal power supply module will be waken up into normal power supply state and begin to provide normal operating voltage to the local electric device; now, the terminal power supply module consumes higher feeding current; when the feeding current exceeds the specified threshold, the power supply module at the local side will judge that the terminal power supply module has entered into normal power supply state, and output the state to other modules at the local side via the remote state output port S; at the same time, the intelligent power supply module at the local side will change the polarity of feeding voltage again under control of the control port G to cut off the diode and thereby stop the buzzer. Owing to the existence of the rectifier module, the normal operating state of the stabilized voltage supply module after the rectifier module will not be affected;

When the terminal power supply module is to be waken up locally, the operator can close the switch hook so as to wake up the terminal power supply module into normal power supply state, and therefore the terminal power supply module will begin to provide normal operating voltage to the local electric device; now, the terminal power supply module consumes higher feeding current; when the feeding current exceeds the specified threshold, the intelligent power supply module at the local side will judge that the terminal power supply module is in normal power supply state, and output the state to other modules at the local side via the remote state output port S.

The voltage polarity monitoring and prompting circuit 5321 can be implemented with a light emitting diode (LED), i.e., when the terminal power supply module is in sleep mode, the LED is in OFF state; when polarity change of feeding voltage is detected, the LED will light up to prompt the operator to close the switch hook K1, so as to wake up the terminal power supply module into normal power supply state; now, the terminal power supply module consumes higher feeding current; when the feeding current exceeds the specific threshold, the intelligent power supply module at the local side will judge that the terminal power supply module is in normal power supply state, and output the state to other modules at the local side via the remote state output port S, and change the polarity of feeding voltage again via the control port G so as to switch off the LED. Owing to the existence of the rectifier module, the normal operating state of the stabilized voltage supply module after the rectifier module will not be affected.

If the stabilized voltage supply module is a stabilized voltage supply module with an Enabled control terminal, the voltage polarity monitoring module 53 will decide whether to provide an Enabled control signal to the stabilized voltage supply module with Enabled terminal so as to activate the stabilized voltage supply module into normal operating state, on the basis of the monitored polarity of feeding voltage.

In that case, an implementation scheme of the voltage polarity monitoring module 53 comprises diodes and resistors simply, as illustrated by the voltage polarity monitoring module 533 in FIG. 11(c1). Implementation of this wake-up procedures are as follows:

Set the polarity of voltage output of the intelligent power supply module in normal state to polarity that causes cut-off of the diodes D6, D7, and D8; in that state, the Enabled terminal of the regulated power supply module is inactive, and therefore the stabilized voltage supply module consumes very low drain current and is in standby state; as a result, the entire terminal power supply module 5 consumes lower feeding current and is in sleep mode;

When the intelligent power supply module is to wake up the terminal power supply module in sleep mode remotely in normal state, the equipment at the local side will control the intelligent power supply module with an control signal inputted via the control port G to output voltage with polarity that causes the diode D6, D7, and D8 to enter into ON state, so that a high-level Enabled signal is provided to the stabilized voltage supply module with an Enabled terminal that is normally in active state under positive voltage by means of the divided voltage on R3 and R4; as a result, the stabilized voltage supply module will be activated to accept long-distance feeding voltage and enter into normal operating state, and output to the local electric device via the local power output port V. Now, the entire terminal power supply module consumes higher feeding current, and therefore enters into normal power supply state;

When the terminal power supply module is to be waken up locally and directly, an Enable signal can be provided to the stabilized voltage supply module 51 through a local control circuit. An implementation scheme of the local control circuit employs a battery and a switch, as shown in FIG. 12; the Enable signal can he generated by closing the switch manually, and thereby the voltage stabilizer module will be activated into normal operating state and thereby wake up the entire terminal power supply module into normal power supply state; then, the terminal power supply module will begin to provide operating voltage to the local electric device; now, the terminal power supply module consumes higher feeding current; when the feeding current exceeds the specified threshold, the intelligent power supply module will judge that the terminal power supply module is in normal power supply state, and will output the state to other modules at the local side via the remote state output port S.

In that case, another implementation scheme of the voltage polarity monitoring module 53 employs a simple combined circuit constituted by diodes, resistors (R5, R6, R7), and a field effect tube (FET), as shown in FIG. 11(c2) by voltage polarity monitoring module 534. Implementation of the wake-up procedures are as follows:

Set the voltage output of the intelligent power supply module in normal state to voltage that causes cut-off of the diode D9; in that state, the FET is in OFF state, the output through the resistor R5 is at high level, the Enabled terminal of the stabilized voltage supply module is inactive, and therefore the stabilized voltage supply module consumes very low drain current and is in standby state; as a result, the entire terminal power supply module 5 consumes lower feeding current and is in sleep mode;

When the intelligent power supply module is to wake up the terminal power supply module in sleep mode remotely in normal state, the equipment at the local side will control the intelligent power supply module with a control signal inputted via the control port G to output the polarity that causes the diode D9 to enter into ON state, so that a low-level Enabled signal will be provided to the corresponding stabilized voltage supply module with an Enabled terminal; as a result, the stabilized voltage supply module will be activated to accept long-distance feeding voltage and enter into normal operating state, and output to the local electric device via the local power output port V after voltage regulation; now, the entire terminal power supply module consumes higher feeding current, and therefore enters into normal power supply state;

When the terminal power supply module is to be waken up locally and directly, an Enabled signal can be provided to the stabilized voltage supply module 51 through a local control circuit. An implementation scheme of the local control circuit employs a battery and a switch, as shown in FIG. 12; the Enabled signal can be generated easily by closing the switch manually, and thereby the voltage stabilizer module will be activated into normal operating state and thereby wake up the entire terminal power supply module into normal power supply state; then, the terminal power supply module will begin to provide normal operating voltage to the local electric device; now, the terminal power supply module consumes higher feeding current; when the feeding current exceeds the specified threshold, the intelligent power supply module a the local side will judge that the terminal power supply module is in normal power supply state, and will output the state to other modules at the local side via the remote state output port S.

In the point-to-point system described above, the terminal power supply module can be hooked with one electric device, or hooked in parallel with multiple electric devices. characterized in that, when the terminal power supply module is waken up into normal power supply state, all the electric devices hooked in parallel with the output terminal of the terminal power supply module can obtain operating voltage required for normal operation.

Hereunder embodiments of two point-to-multipoint long-distance constant voltage feeding methods and systems with wake-up function will be described.

The core method of a first embodiment is: arranging an intelligent power supply module at the local side, arranging a terminal power supply module at the terminal, and connecting the intelligent power supply module and the terminal power supply module through a feeder line.

The terminal power supply module has multichannel stabilized voltage supply output modules connected in parallel, and each stabilized voltage supply output module is in standby state initially; when a stabilized voltage supply output module is waken up remotely or locally into normal power supply state, it will begin to provide operating voltage required for normal operation to a electric device connected to it or multiple electric devices connected in parallel; now, the consumed current in the feeder line will increase accordingly.

The intelligent power supply module feeds constant-voltage feeding with determined polarity to the terminal power supply module in normal state; when a stabilized voltage supply output module in standby state in the terminal power supply module is to be waken up remotely in normal state, the polarity of outputted feeding voltage will be changed in accordance with predefined rules, and the feeding current in the feeder line will be monitored constantly; if the intelligent power supply module finds the feeding current increases by a specified value, it will judge that a stabilized voltage supply output module in standby state in the terminal power supply module has entered into normal power supply state; if the intelligent power supply module finds the feeding current decreases by a specified value, it will judge that a stabilized voltage supply output module in the terminal power supply module has entered into standby state; in addition, the intelligent power supply module will output the monitored standby state/normal power supply state of the stabilized voltage supply output module in the terminal power supply module to other modules at the local side.

The implementation method for the intelligent power supply module remotely in normal state to wake up a stabilized voltage supply output module in standby state in the terminal power supply module into normal power supply state is: arranging a voltage polarity control circuit in the intelligent power supply module, wherein, the voltage polarity control circuit will invert the polarity of outputted feeding voltage as a wake-up signal for waking up a stabilized voltage supply output module in standby state in the terminal power supply module, as instructed by the control instructions of other modules at the local side, when the stabilized voltage supply output module in standby state is to be waken up; arranging a voltage polarity monitoring module in the terminal power supply module, wherein, the voltage polarity monitoring module will activate the stabilized voltage supply output module from standby state into normal power supply state, when it detects the corresponding wake-up signal.

The implementation method for waking up a stabilized voltage supply output module in standby state in the terminal power supply module into normal power supply state locally is: providing a local control circuit to each stabilized voltage supply output module, so as to wake up the stabilized voltage supply output module into normal power supply state when the stabilized voltage supply output module is to be waken up locally.

Hereunder the methods described above will be detailed in an example of the implementation circuit of a point-to-multipoint long-distance constant-voltage feeding system with wake-up function.

The point-to-multipoint long-distance constant-voltage feeding system with wake-up function comprises an intelligent power supply module 4, a terminal power supply module 5, and a feeder line 6 that connects the intelligent power supply module 4 and the terminal power supply module 5, as shown in FIG. 3. The connection of intelligent power supply module 4 and terminal power supply module 5 through the feeder line 6 and the implementation of the intelligent power supply module 4 are the same as those in the point-to-point scheme, and will not he detailed further here. However, the implementation of the terminal power supply module is different to that in the point-to-point scheme. Hereunder an implementation scheme of the terminal power supply module 5 will be introduced.

The terminal power supply module 5 has a voltage polarity monitoring module 53 and a stabilized voltage supply module 51.

An implementation scheme of the stabilized voltage supply module 51 comprises a rectifier bridge, diodes, stabilized voltage supply output modules with an Enabled control terminal (5131, 5132, . . . , 513N), local power output ports (V1, V2, . . . , VN), and local control ports (C1, C2, . . . , CN), as illustrated by the module 513 in FIG. 13.

The input terminals of the stabilized voltage supply output modules with an Enable control terminal (5131, 5132, . . . , 513N) are directly connected to the input terminal of the feeder line via the rectifier bridge, and the Enabled terminal of each stabilized voltage supply output module with an Enabled control terminal is in inactive state initially, i.e., the stabilized voltage supply output modules with an Enabled control terminal are in standby state initially, consume very low drain current, and output zero output voltage; when the Enabled control terminal of a certain stabilized voltage supply output module with an Enabled control terminal changes to active state, the stabilized voltage supply output module with an Enabled control terminal will output rated operating voltage, enter into normal power supply state, and provide normal operating voltage to the connected local electric device.

An implementation scheme of the voltage polarity monitoring module 53 comprises a voltage polarity change parameter recording and processing module 5351 and a voltage polarity change sensing circuit constituted by diodes (D10, D11, D12) and resistors (R8 and R9), as illustrated by the module 535 in FIG. 13. The voltage polarity change parameter recording and processing module 5351 can have one input terminal and multiple output terminals, wherein, the input terminal is connected to the output terminal of the voltage polarity change sensing circuit, and each output terminal is connected to the control terminal of a stabilized voltage supply output module with an Enabled control terminal; when the voltage polarity change parameter recording and processing module 5351 receives a different voltage polarity change parameter from the voltage polarity change sensing circuit, it will output an Enabled control signal required for waking up the stabilized voltage supply output module with an Enabled control terminal to the corresponding output terminal. The required function of the voltage polarity change parameter recording and processing module 5351 can be implemented by simply programming the input/output terminals of a single-chip microcomputer or other information processing module. Implementation of this wake-up procedures are as follows:

Set the intelligent power supply module 4 to output feeding voltage with determined polarity in normal state; when a stabilized voltage supply output module with an Enabled control terminal in standby state in the terminal power supply module is to be waken up in normal state, the intelligent power supply module 4 will change the polarity of outputted feeding voltage in accordance with predefined and monitor the magnitude of feeding current in the feeder line constantly; if the intelligent power supply module 4 finds the feeding current has increased by a specified value, it will judge that a power output module with an Enabled control terminal in the terminal power supply module has entered into normal power supply state; if the intelligent power supply module 4 finds the feeding current has decreased by the specified value, it will judge that an power output module with an Enabled control terminal in the terminal power supply module has entered into standby state; in addition, the intelligent power supply module 4 will output the monitored standby state/normal power supply state of the power output module with an Enabled control terminal in the terminal power supply module to other modules at the local side;

When the intelligent power supply module 4 in normal state is to remotely wake up a stabilized voltage supply module with an Enabled control terminal in standby state in the terminal power supply module 513 into normal power supply state, it will invert the polarity of the outputted feeding voltage as a wake-up signal for waking up the stabilized voltage supply output module with an Enabled control terminal in accordance with predefined rules with the control signal inputted via the port G, so that the voltage polarity monitoring module 535 in the terminal power supply module can activate the stabilized voltage supply output module with an Enabled control terminal in standby state connected to its corresponding output terminal into normal power supply state according to the monitored wake-up signal, and thereby the stabilized voltage supply output module with an Enabled control terminal will provide normal operating voltage to the connected local electric device; in that state, the consumed current in the feeder line will increase by a specific value;

When a stabilized voltage supply output module with an Enabled control terminal is to he directly waken up locally into normal power supply state, an Enabled signal can be provided from the local control port controlled by the corresponding local control circuit to activate the stabilized voltage supply output module with an Enabled control terminal into normal power supply state. An implementation scheme of the local control circuit is shown in FIG. 12.

The core method of a second embodiment is: arranging an intelligent power supply module at the local side, adding a power supply module in each electric device connected in parallel at the terminal to form a terminal power supply module, and connecting the intelligent power supply module and the terminal power supply module through a feeder line.

The power supply module for each electric device in the terminal power supply module is in sleep mode initially; when the power supply module for certain electric device is waken up remotely or locally, it will enter into normal power supply state, and begin to provide operating voltage required for normal operation to other functional modules in the electric device; now, the consumed current in the feeder line will increase by a specific value.

The intelligent power supply module feeds constant-voltage feeding with determined polarity to the terminal power supply module in normal state; when the power supply module for certain electric device in standby state in the terminal power supply module is to be waken up remotely in normal state, the polarity of outputted feeding voltage will be changed in accordance with predefined rules, and the feeding current in the feeder line will be monitored constantly; if the intelligent power supply module finds the feeding current increases by a specified value, it will judge that the power supply module for certain electric device in the terminal power supply module has entered into normal power supply state; if the intelligent power supply module finds the feeding current decreases by a specified value, it will judge that the power supply module for certain electric device in the terminal power supply module has entered into sleep mode; in addition, the intelligent power supply module will output the monitored sleep mode/normal power supply state of the power supply module for the electric device in the terminal power supply module to other modules at the local side.

The implementation method for the intelligent power supply module in normal state to remotely activate the power supply module for a specified electric device from sleep mode into normal power supply state is: arranging a voltage polarity control circuit in the intelligent power supply module, wherein, the voltage polarity control circuit can invert the polarity of outputted feeding voltage as a wake-up signal for waking up the power supply module of the electric device in sleep mode when the power supply module for the specified electric device in sleep mode is to be waken up into normal power supply state as instructed by the control instructions of other modules at the local side; arranging a voltage polarity monitoring module in the power supply module of electric device to identify the corresponding wake-up signal and according to the monitored wake-up signal, enabling the stabilized voltage supply module with an Enabled control terminal in the power supply module for the electric device so as to activate the stabilized voltage supply module into normal operating slate, and thereby wake up the power supply module for the electric device from sleep mode to normal power supply state; thus, the power supply module will begin to provide normal operating voltage to other functional modules in the electric device; now, the consumed current in the feeder line will increase by a specific value. It is important to note: a wake-up signal with specific characteristics can only be used to wake up a specific power supply module, i.e., each power supply module can only identify a specific wake-up signal for waking up it.

The implementation method for locally waking up the power supply module for certain electric device in sleep mode into normal power supply state is: providing a local control circuit for the stabilized voltage supply module with an Enabled control terminal in the power supply module for the electric device, and activating the stabilized voltage supply module into normal operating state, and thereby waking up the power supply module into normal power supply state to provide normal operating voltage to other functional modules in the electric device, when the power supply module for the electric device is to be waken up from sleep mode locally; now, the consumed current in the feeder line will increase by a specific value.

Hereunder the methods described above will be detailed in an example of the implementation circuit of a point-to-multipoint long-distance constant-voltage feeding system with wake-up function.

The point-to-multipoint long-distance constant-voltage feeding system with wake-up function comprises: an intelligent power supply module 4, a terminal power supply module 7 constituted by multiple power supply modules (71, 72, . . . , 7N) for electric devices at distal end, and a feeder line 6 for connecting the intelligent power supply module 4 and the terminal power supply module 7, as shown in FIG. 14. The connection method of intelligent power supply module 4 at the local side and terminal power supply module 7 to the feeder line 6 and the implementation method of the intelligent power supply module 4 are the same as those in the point-to-point scheme, and will not be detailed further here. However, the implementation of the terminal power supply module is different to that in the point-to-point scheme. Hereunder a specific implementation scheme of the terminal power supply module will be introduced.

An implementation scheme of the terminal power supply module 7 comprises power supply modules (71, 72, . . . , 7N) connected in parallel for multiple electric devices, as indicated by the terminal power supply module 7 FIG. 14.

The power supply modules (71, 72, . . . , 7N) for the electric devices are in sleep mode initially; they will enter into normal power supply state and begin to provide normal operating voltage to other functional modules in the electric devices and feed back the power supply state signal thereof to the intelligent power supply module 4 through the feeder line 6, after they are waken up.

The power supply modules (71, 72, . . . , 7N) for the electric devices have very low leak current in sleep mode respectively; once a power supply module is waken up into normal power supply state, the current in the feeder line will increase by a specific value.

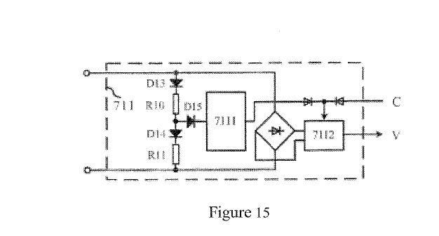

An implementation scheme of the power supply modules (71, 72, . . . , 7N) for the electric devices in this embodiment comprises a voltage polarity change sensing circuit constituted by diodes (D13, D14, and D15) and resistors (R10 and R11), a voltage polarity change parameter recording and processing module 7111, and a stabilized voltage supply module 7112 with an Enabled control terminal, as indicated by the power supply module 711 for electric device in FIG. 15.

The voltage polarity change parameter recording and processing module 7111 can have one input terminal and one output terminal, and the input terminal is connected to the output terminal of the voltage polarity change sensing circuit, and the output terminal is connected to the control terminal of the stabilized voltage supply module with an Enabled; when the voltage polarity change parameter recording and processing module 7111 receives a specific voltage polarity change parameter from the voltage polarity change sensing circuit, it will treat the voltage polarity change parameter and output from its output terminal an Enabled control signal required for activating the regulated power supply module with an Enabled control terminal connected to it. The required function of the voltage polarity change parameter recording and processing module 7111 can be implemented by simply programming the input/output terminals of a single-chip microcomputer or other information processing module Implementation of this wake-up procedures are as follows:

Set the intelligent power supply module 4 to output feeding voltage with determined polarity in normal state; when the power supply module in sleep mode for a specified electric device is to be waken up remotely, the intelligent power supply module 4 will invert the polarity of the outputted feeding voltage as a wake-up signal for waking up the power supply module in sleep mode for the electric device in accordance with predefined rules with a control signal inputted via the port G, and monitor the magnitude of the feeding current in the feeder line constantly; if the intelligent power supply module 4 finds the feeding current has increased by a specific value, it will judge that the power supply module for the electric device has enter into normal power supply state; if the intelligent power supply module 4 finds the feeding current has decreased by a specific value, it will judge that the power supply module for the electric device has enter into sleep mode; in addition, the intelligent power supply module 4 will output the monitored sleep mode/normal power supply state of the power supply module for the electric device to other modules at the local side;

When the intelligent power supply module 4 in normal state is to remotely wake up the power supply module of a specified electric device into normal power supply state, the equipment at the local side will control the intelligent power supply module 4 with an control signal inputted via the control port G to invert the polarity of outputted feeding voltage as a wake-up signal for waking up the power supply module for the electric device on the basis of predefined rules; the voltage polarity change parameter recording and processing module 7111 in the power supply module for the electric device will record the voltage polarity change parameter and identify the wake-up signal by means of the voltage polarity change sensing circuit, treat the voltage polarity change parameter, and output an Enabled control signal to the stabilized voltage supply module thereafter to activate the stabilized voltage supply module into normal operating state, and thereby wake up the power supply module for the electric device from sleep mode into normal power supply state; thus, the power supply module will begin to provide normal operating voltage to other functional modules in the electric device; now, the consumed current in the feeder line will increase by a specific value;

If the power supply module for a specific electric device is to be directly waken up locally into normal power supply state, a local control circuit can be arranged in the stabilized voltage supply module in the power supply module for the electric device to provide an Enabled signal, so as to activate the power supply module into normal power supply state. An implementation scheme of the local control circuit can be implemented by the circuit shown in FIG. 12.

It is noted that the description in this document is only illustrative, and shall not be deemed as constituting any limitation to the present invention. The protected scope of the present invention shall be confined by the claims only.

1. A long-distance constant-voltage feeding method with wake-up function, comprising an intelligent power supply module, a terminal power supply module, and a feeder line that connects the intelligent power supply module and the terminal power supply module, wherein, the intelligent power supply module can provide constant-voltage feeding to the terminal power supply module constantly, and can change the polarity of feeding voltage in accordance with predefined rules when the terminal power supply module in sleep mode is to be waken up remotely;
the intelligent power supply module monitors the active state of the terminal power supply module constantly, and outputs the monitored active state of the terminal power supply module to other modules at the local side;
the terminal power supply module is in sleep mode initially and consumes lower feeding current, and will consume higher feeding current and begin to provide normal operating voltage to the locally connected electric device after it is waken up and enters into normal power supply state.

2. The long-distance constant-voltage feeding method with wake-up function according to claim 1, wherein, the terminal power supply module comprises a voltage polarity monitoring module that monitors the polarity of feeding voltage from the local side.

3. The long-distance constant-voltage feeding method with wake-up function according to claim 2, wherein, the voltage polarity monitoring module decides whether to wake up the remote terminal power supply module from sleep mode into normal power supply state according to the monitored polarity of feeding voltage from the local side.

4. The long-distance constant-voltage feeding method with wake-up function according to claim 2, wherein, the voltage polarity monitoring module decides whether to wake up the remote terminal power supply module from sleep mode into normal power supply state according to the monitored parameter of polarity change of feeding voltage from the local side.

5. A long-distance constant-voltage feeding system with wake-up function, comprising: an intelligent power supply module, a terminal power supply module, and a feeder line that connects the intelligent power supply module and the terminal power supply module, wherein, the intelligent power supply module comprises a power supply module that can provide constant-voltage feeding to the terminal power supply module constantly, a voltage polarity control module that will change the polarity of feeding voltage in accordance with predefined rules when the terminal power supply module in sleep mode is to be waken up remotely, and a current detection module that monitors the active state of the terminal power supply module constantly and outputs the monitored active state of the terminal power supply module to other modules at the local side;
the terminal power supply module is in sleep mode initially and consumes lower feeding current, and will consume higher feeding current and begin to provide normal operating voltage to the locally connected electric device after it is waken up and enters into normal power supply state.

6. The long-distance constant-voltage feeding system with wake-up function according to claim 5, wherein, the terminal power supply module comprises a voltage polarity monitoring module and a stabilized voltage supply module.

7. The long-distance constant-voltage feeding system with wake-up function according to claim 6, wherein, the voltage polarity monitoring module decides whether to wake up the remote terminal power supply module from sleep mode into normal power supply state according to the monitored polarity of feeding voltage from the local side.

8. The long-distance constant-voltage feeding system with wake-up function according to claim 6, wherein, the voltage polarity monitoring module can decide whether to activate the stabilized voltage supply module into normal operating state according to the monitored parameter of polarity change of the feeding voltage from the local side.

9. The long-distance constant-voltage feeding system with wake-up function according to claim 6, wherein, the stabilized voltage supply module is in standby state initially, and will enter into normal operating state after it is activated; in addition, the stabilized voltage supply module consumes very low current in standby state, and provides normal operating voltage to the connected electric device after it and consumes higher current in normal operating state.
